(19) United States
(12) Patent Application Publication
(10) Pub. No.: US 2022/0164430 A1
(43) Pub. Date: May 26, 2022

(54) Method For Identifying And Authenticating A User Profile

(71) Applicants: Mark Aleksandrovich NECHAEV, Achinsk Town (RU); Faisal Ashfaq Satti MOHAMMAD, Islamabad (PK)

(72) Inventor: Faisal Ashfaq Satti Mohammad, Islamabad (PK)

(21) Appl. No.: 17/602,794

(22) PCT Filed: Apr. 16, 2019
(86) PCT No.: PCT/RU2019/000255

§ 371 Date: Oct. 11, 2021

(51) Int. Cl. G06F 21/36; H04L 67/306; H04L 9/40

(52) U.S. Cl. CPC G06F 21/36; H04L 63/0823; H04L 67/306

(57) ABSTRACT

A method of identifying and authenticating a user profile is provided. The method allows us to solve technical problem of lack of effective and fast ways to identify fake user profiles on the Internet, an effective way to prevent creation of fake profiles and expands an arsenal of tools to protect copyright content on the Network from copying. The technical result is achieved by the fact that it is a method of identifying and authenticating a user profile on a website, in a social network or in a messenger on the Internet, characterized in that when creating a user profile, a unique code is automatically assigned to this profile, which is displayed directly in the user profile so that the unique code is available for viewing by any other Internet users, at the same time, the user can designate the content posted in his profile with this unique code.

### CROSS-REFERENCE TO RELATED APPLICATIONS

This application is a national stage application of the Patent Cooperation Treaty (PCT) international application titled “METHOD FOR IDENTIFYING AND AUTHENTICATING A USER PROFILE”, international application number PCT/RU2019/000255, filed in the Russian Patent Office on Apr. 16, 2019. The specification of the above referenced Patent application is incorporated herein by reference in its entirety.

### FIELD OF THE INVENTION

The invention relates to the field of digital data processing using electrical devices in wireless communication networks, namely to identification, for example, confirmation of the user's identity, user authentication, and can be used to identify and authenticate the user's profile on the Internet.

### BACKGROUND

A technical solution is known for the international patent for the invention N° US2018260543 (priority date 13 Sep. 2018) “Automated user profile generation and authentication”. This technical solution is characterized by the fact that it is a system and methods for automatically generating a user profile and authentication. One system includes a database that stores user profile data for multiple users, and an electronic processor that is communicatively connected to the database. The electronic processor is designed with the ability to receive from the computing device the first usage indicator for the first user and the first user ID for the first user and to generate a probable user profile based on the first usage indicator and the first user ID. The electronic processor is designed with the ability to extract a set of pre-generated user profiles from the database and determine a confidence indicator for each of the previously generated user profiles based on a probable user profile. The following essential features of this technical solution coincide with the claimed technical solution “Method of identification and authentication of the user profile”: this technical solution is a method of identification and authentication of the user profile.

The closest technical solution (prototype) is a technical solution for an international patent for an invention CN 107451434 (priority date 14 Aug. 7) “Method and system for identifying the content of a web page”. This technical solution is characterized by the fact that it reveals the method and system for identifying the content of a web page. Security certification is carried out on the client at the web page development stage in advance, and specific characters are added to the corresponding page URL when creating web pages, and then certain characters are also loaded by the user; when it is necessary to identify network content, whether the network content website is pre-determined, as soon as the website is secure, the network content can be identified. The invention solves the problem of the difficulty of identification for the security of network content, and the current network content is eventually solved in the real sense, eventually the identification of the security of web content is achieved, unnecessary web pages are isolated and ultimately network security is increased. The following essential features of this technical solution coincide with the claimed technical solution “Method of identification and authentication of the user profile”: the method involves identifying the content of a web page by a unique sequence of characters

The technical solutions listed above have a number of disadvantages:
the technical solution for the patent for the invention CN 107451434 is limited to identifying only the web page using the URL of the page;
the technical solution under the patent for the invention No. US2018260543 implies the use of a complex system (database, electronic processor) for the implementation of user profile authentication.

### SUMMARY OF THE INVENTION

### Method of Identification and Authentication of the User Profile

The invention relates to the field of digital data processing using electrical devices in wireless communication networks, namely to identification, for example, confirmation of the user's identity, user authentication, and can be used to identify and authenticate the user's profile on the Internet.

The claimed method of identifying and authenticating a user profile allows us to solve the technical problem of the lack of effective and fast ways to identify fake user profiles on the Internet, an effective way to prevent the creation of fake profiles and expands the arsenal of tools to protect copyright content on the Network from copying.

The technical result is achieved by the fact that the claimed method of identifying and authenticating a user profile is characterized by the fact that it is a method of identifying and authenticating a user profile on a website, in a social network or in a messenger on the Internet, characterized in that when creating a user profile, a unique code is automatically assigned to this profile, which is displayed directly in the user profile so that the unique code is available for viewing by any other Internet users, at the same time, the user can designate the content posted in his profile with this unique code.

### DETAILED DESCRIPTION OF THE INVENTION

In contrast to the above analogues, the technical solution claimed for registration “Method of identification and authentication of the user profile” provides for the possibility of identification and authentication of the user profile on the Internet in an extremely simple and visual way for other users so that any other user can identify a fake profile. At the same time, this method will also allow you to additionally secure the authorship of the user's content that he posted in the profile.

The claimed method of identifying and authenticating a user profile allows us to solve the technical problem of the lack of effective and fast ways to identify fake user profiles on the Internet, an effective way to prevent the creation of fake profiles and expands the arsenal of tools to protect copyright content on the Network from copying.

Accordingly, the technical result of the claimed technical solution “Method of identification and authentication of the user profile” is that this method of identifying a user's profile on the Network is extremely simple and clear for other network users, any user can identify whether it is a fake or a real user profile, which increases the efficiency and speed of detecting fake user profiles on the Internet, while this method will also allow you to additionally secure the authorship of the content (photos, videos, texts, etc.) of the user that he posted in the profile, which will strengthen his protection and reduce the number of copying cases.

The technical result is achieved by the fact that the claimed method of identifying and authenticating a user profile is characterized by the fact that it is a method of identifying and authenticating a user profile on a website, in a social network or in a messenger on the Internet, characterized in that when creating a user profile, a unique code is automatically assigned to this profile, which is displayed directly in the user profile so that the unique code is available for viewing by any other Internet users, at the same time, the user can designate the content posted in his profile with this unique code.

To obtain a technical result, the invention can be carried out as follows. The user registers on a website, social network or messenger and is automatically assigned a unique code that is displayed directly in the user's profile so that the unique code is available for viewing by any other Internet users, for example, next to the user's name, in the user status, etc. In this case, the user can use this unique code to designate content (photos, videos, audio recordings, texts, etc.), which he places in the profile. For example, the user can put the code in a video, audio recording, on a photo or in text. In the future, if another user creates an identical fake user profile with the same content, he will be assigned a different unique code that will be displayed in the profile, and the unique code that indicates the content will, accordingly, differ from the unique code specified in the fake profile. Thus, a unique code will not only distinguish one profile from another, but also allow you to compare the content of a fake profile indicated by a unique code with the code of this profile to determine that it is fake.

The presented invention differs in that the use of this method of identifying and authenticating a user profile allows you to quickly and easily identify a fake or real user profile for other users, as well as to secure and protect the authorship of the user's content that he posted in the profile.

I claim:

1. A method of identifying and authenticating a user profile is characterized by the fact that it is a method of identifying and authenticating a user profile on a website, in a social network or in a messenger on the Internet, characterized in that when creating a user profile, a unique code is automatically assigned to this profile, which is displayed directly in the user profile so that the unique code is available for viewing by any other Internet users, while the user can designate the content posted in his profile, with this unique code.
